(19) United States
(12) Patent Application Publication
(10) Pub. No.: US 2010/0023185 A1
(43) Pub. Date: Jan. 28, 2010

(54) DEVICES AND METHODS FOR WAYPOINT TARGET GENERATION AND MISSION SPOOLING FOR MOBILE GROUND ROBOTS

(75) Inventors: Christopher Rome Terwelp, Blacksburg, VA (US); Michael Ryals Fleming, Christiansburg, VA (US); Brett Anthony Gombar, Blacksburg, VA (US); Benjamin Edward Hastings, Christiansburg, VA (US); Michael Vincent Avitabile, Blacksburg, VA (US)

Correspondence Address: Thomas, Raring, & Teague, P.C., 536 GRANITE AVENUE, RICHMOND, VA, 23226, US

(73) Assignee: TORC Technologies, LLC, Blacksburg, VA (US)

(21) Appl. No.: 12/180,883

(22) Filed: Jul. 28, 2008

(51) Int. Cl. G05D 1/00; G01C 21/00; G01C 3/08; G01C 3/00

(52) U.S. Cl. 701/2; 701/206; 356/4.01; 701/224; 701/213; 356/3; 901/1

(57) ABSTRACT

Embodiments of the present invention improve mobile robot guidance and control by providing a position designation system for an unmanned vehicle, such as a mobile ground robot. This system allows an operator to select locations of interest on earth for the robot by pointing at the locations through an optical device that is able to discern global or local coordinates of the locations of interest. These waypoints may be spooled directly to the robot or through other mission planning elements that will make decisions about what to do with these locations of interest.

### FIELD OF THE INVENTION

The present invention relates generally to a human-machine interface for the control of a mobile robot, and more particularly with methods of and systems for remotely sensing and communicating waypoints to a robot from a hand-held laser pointing device.

### BACKGROUND

A mobile ground robot is a mechanical and electrical device that operates by travelling to one or more locations dictated by a mission planner and typically performing one or more tasks at those locations. Mobile ground robots are increasingly being used by militaries around the world and by many civilian law enforcement agencies. A mobile ground robot may be used, for example, by explosive ordnance disposal (EOD) operators (military or law enforcement) to examine and disarm or destroy potential explosive devices (such as improvised explosive devices (IEDs) encountered by military personnel). Such a robot may be generically termed an Unmanned Ground Vehicle (UGV). EOD operators must maintain a safe distance from the IED. Additionally, in combat situations the EOD operators may need to minimize exposure to hostile forces.

Getting the robot from the operator's location to the location of the IED is a time consuming task that can expose the UGV operator to significant risk. Some UGVs are controlled in real-time using a joystick to steer the UGV as the UGV drives to the target destination (similar to driving a radio-controlled toy car). This method of controlling a UGV requires the operator to maintain visual contact via video link or other means with the UGV during the entire transit time, thereby potentially exposing the operator to hostile fire. As UGVs are commonly deployed several hundreds of meters from an IED, it can take up to ten minutes for the UGV to reach the IED.

### BRIEF SUMMARY

Embodiments of the present invention improve mobile robot guidance and control by providing a position designation system for an unmanned vehicle, such as a mobile ground robot. Embodiments of the invention also improve operator speed and ease of communicating instructions to a robot, and allow an operator to convey gesture-based instructions to a robot. This system allows an operator to select locations of interest on earth for the robot by pointing at the locations through an optical device that is able to discern global or local coordinates of the locations of interest. The system spools waypoint instructions directly to the robot or through other mission planning elements that will make decisions about what to do with these locations of interest.

In one embodiment of the invention, a device for waypoint designation comprises a distance sensor, an orientation sensor, a position sensor, and a controller. The distance sensor, which may comprise a laser rangefinder, is configured for determining a distance between the device and a desired waypoint. The orientation sensor, which may comprise an electronic compass, is configured for determining a heading and a pitch of the device when the device is pointed at the desired waypoint. The position sensor, which may comprise a global positioning system receiver, is configured for determining a position of the device. The controller is configured for determining a position of the desired waypoint using the heading, pitch, and position of the device and the distance between the device and the desired waypoint.

The device may further comprise a user input element for receiving an input from a user when the device is pointed at the desired waypoint. In such an embodiment, the distance sensor determines the distance between the device and the desired waypoint when the user input is received, the orientation sensor determines the heading and pitch of the device when the user input is received, and the position sensor determines the position of the device when the user input is received.

The device may further comprise a sighting element aligned with the distance sensor such that the viewing the desired waypoint in the sighting element causes the distance sensor to be pointed at the desired waypoint.

The device may further comprise a communication element. In one embodiment, the communication element is configured for communicating the position of the desired waypoint to an ordnance fire control system. In another embodiment of the invention, the communication element is configured for communicating with a mobile ground robot, and the controller is configured for sending, via the communication element, the determined position of the desired waypoint to the mobile ground robot, thereby causing the mobile ground robot to (i) move to the desired waypoint and/or (ii) perform a desired action at the desired waypoint. The communication sent by the controller to the robot may conform to the Joint Architecture for Unmanned Systems standard.

In addition to the device for waypoint designation as described above, other aspects of the present invention are directed to corresponding methods for waypoint designation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1. is a schematic block diagram of a device for waypoint designation, in accordance with embodiments of the present invention;

FIG. 2 is a schematic block diagram illustrating a method for waypoint designation using the device of FIG. 1, in accordance with one embodiment of the invention; and

FIG. 3 is a schematic block diagram illustrating a method for waypoint designation using the device of FIG. 1, in accordance with another embodiment of the invention.

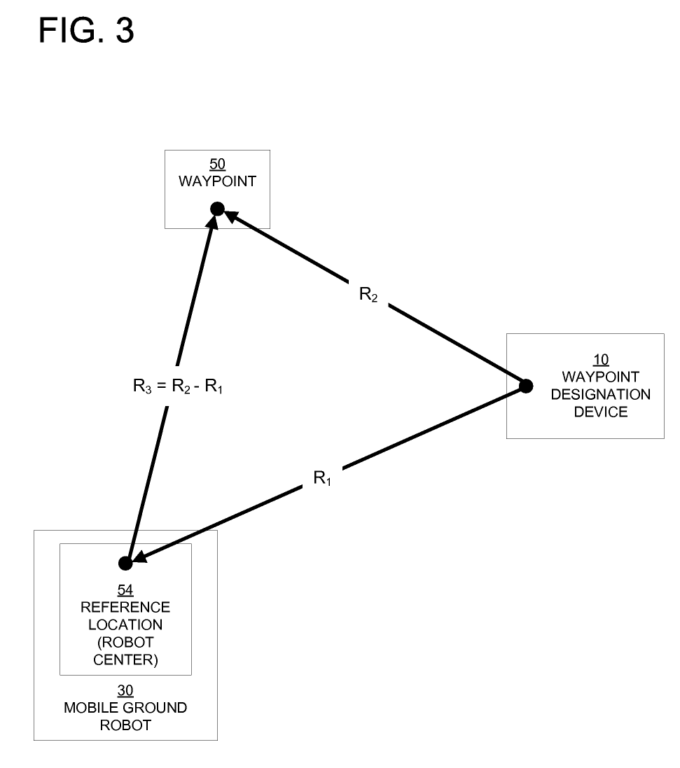

### DETAILED DESCRIPTION

Embodiments of the invention comprise a hand-held laser-based position designator used by an operator to communicate visually observed target waypoints and related mission data from the operator to a remote mobile autonomous or semi-autonomous mobile machine (robot). This new technology will allow operators to use human gestures to impart commands to the increasingly automated systems. However, this product has extensions beyond military unmanned ground vehicles. While embodiments of the invention are described herein in relation to unmanned ground vehicles, embodiments of the invention are useful for many applications requiring the remote designation of locations.

In one embodiment of the present invention, the device for waypoint designation is embodied in a handheld binocular or monocular device capable of localizing and commanding a target waypoint to an unmanned vehicle. The operator sights a target, such as a suspected IED, by placing the device's crosshairs on a nearby navigation target. Once sighted, the operator depresses a button on the device and the target waypoint is transmitted to software elements that control the motion of the mobile robot.

Multiple waypoints may be selected and communicated to the mobile robot in this manner. In one embodiment of the invention, these multiple waypoints define a virtual path along which the robot is to travel. By selecting an appropriate virtual path, the operator can enable the robot to avoid obstacles without requiring the robot to have on-board obstacle-avoidance capability (although it may be desirable to have such on-board obstacle-avoidance capability as a backup system). In an alternative embodiment of the invention, these multiple waypoints define a perimeter within which the robot is to travel or avoid. For example, a robot may be designed to search for antipersonnel mines in a suspected minefield by traveling on a predetermined back-and-forth search pattern. The device may be used to define the perimeter of the desired search area, such that the robot will confine its search to within the defined perimeter.

In one embodiment of the invention, communications between the device and the unmanned vehicle conform to the JAUS (Joint Architecture for Unmanned Systems) standard (also identified as the Aerospace-4 (AS-4) Standard of the Society for Automotive Engineers). JAUS is a transport layer independent communication standard designed for intercommunication of mobile robots and unmanned systems, including but not limited to payloads, sensors, and operator control units. In JAUS terminology, software elements that may receive waypoints may be a mission planner or a waypoint driver. The mission planner is a JAUS service that transmits waypoints and other mission data based off of predetermined intervals or aperiodic events. The waypoint driver is a JAUS service that enables autonomous waypoint navigation in unmanned systems by controlling the mobile robot's drive system.

Once the waypoint driver receives the target waypoint(s) from the device, the waypoint driver drives the UGV to the target waypoint(s). By fusing the functionalities of the device and a waypoint driver, an EOD operator can sight and command a UGV to travel to an IED with minimal time on terminal and with minimal exposure to hostile forces. Once commanded, the EOD operator is not required to assist the UGV during its autonomous navigation to its target. The device allows the EOD operator to focus on other critical tasks during UGV transit time. While embodiments of the invention are described herein as conforming to the JAUS/SAE AS-4 standard, embodiments of the invention are not limited to conforming to the JAUS/SAE AS-4 standard and are capable of conforming to any appropriate communications/control standard.

The communicated instructions allow the robot to perform one or more missions involving each waypoint (whether movement along a path defined by several waypoints and/or travel to a single “destination” waypoint, and/or tasks performed at one or more waypoint), where “waypoint” means a physical point in space.

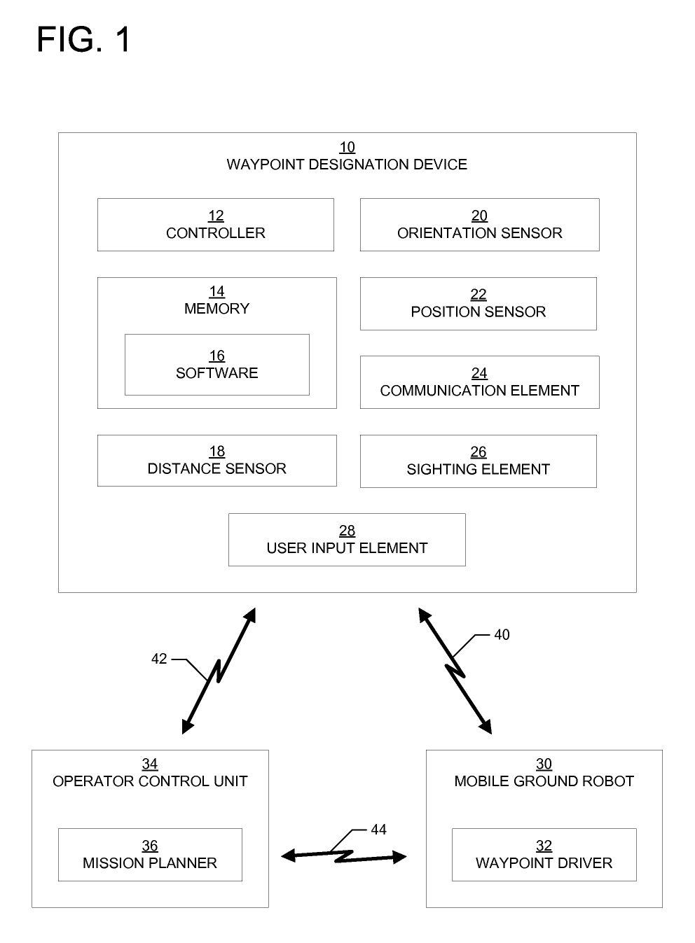

Referring now to FIG. 1, a schematic block diagram of a device for waypoint designation is illustrated in accordance with embodiments of the present invention. The device 10 for waypoint designation of the present invention comprises: (1) a distance sensor 18 that measures distance to an object (e.g., a laser rangefinder); (2) an orientation sensor 20 that measures heading and pitch (e.g., an electronic compass); (3) a position sensor 22 that provides a reference position (e.g., a global positioning system (GPS) receiver); (4) a controller 12 to interface with the sensors and communicate with the mobile robot 30 or operator control unit 34; (5) software code 16 (stored in memory 14) to acquire, analyze, filter, store, and send the data; (6) a mechanical enclosure (not illustrated) to house the system and support exterior buttons and controls; (7) a communication element 24 for communicating to the mobile robot 30 or the operator control unit 34; (8) a sighting element 26 through which the operator “aims” the device at the desired waypoint; and (9) a user input element (comprising, e.g., a plurality of pushbuttons).

The distance sensor 18 typically comprises a laser rangefinder that emits a beam of light which reflects off a sighted target and returns to the emitter/collector. Using the constant speed of light, distance is calculated by measuring the time of flight of the reflected light pulse. A commercially available light emitting, ranging device may be used. The operator sights the target using the sighting element 26, which may be a viewfinder or a camera feed to a display screen (embodiments of the invention will be described herein in which the sighting element is a viewfinder). The orientation sensor 20 typically comprises an electronic compass (comprising, e.g., a magnetometer and tilt sensor) that is capable of determining the orientation of the device relative to a known coordinate frame such as the earth. The orientation information used by at least some embodiments of the invention comprises heading and pitch (also termed inclination or tilt). The position sensor typically comprises a GPS receiver that determines the absolute position of the device in space with respect to a known coordinate frame such as the earth. The controller is able to use the distance to the waypoint (determined by the distance sensor), the orientation of the device (determined by the orientation sensor) and the position of the device (determined by the position sensor) to determine the position of the waypoint.

The position of the waypoint may comprise a two-dimensional position or a three-dimensional position, or the waypoint position may comprise four or more dimensions (additional dimensions may include, for example, time of arrival or heading of the robot upon arrival). For example, in alternative embodiments of the invention the waypoint position may comprise (i) a latitude and a longitude, (ii) a latitude, a longitude, and a heading, (iii) a latitude, a longitude, and an elevation, or (iv) a latitude, a longitude, a heading, and an elevation, but any suitable coordinate frame system may be used. In one embodiment of the invention, all waypoints must be connected to the surface of the earth (or whatever planet on which the device is being used). Knowing the pitch of the device, which is particularly useful for determining a three-dimensional position, increases the accuracy of the determined two-dimensional position.

The device's sensor components may be integrated into a single package that may be hand-held or mounted to another pointing device such as a rifle barrel held by a soldier or mounted to a mobile robot. Alternatively, the sensor components may be spatially distributed and their data may integrated by software elements at another location such as within a software process on an operator control unit.

The controller 12 interfaces to the sensors and the communications element, accepts input from the user (via the user input element 28), and provides status to the user (via a display element that is not illustrated). The controller is also responsible for executing the software, described below. The controller may be comprised of a microprocessor, dedicated or general purpose circuitry (such as an application-specific integrated circuit or a field-programmable gate array), a suitably programmed computing device, or any other suitable means for controlling the operation of the device.

The communication element 24 enables (via a wired or wireless communication link) communication between the device and the mobile ground robot 30 and/or between the device and an operator control unit 34. For example, the device may send the waypoint(s) directly to the waypoint driver 32 of the robot over communication link 40. Alternatively, the device may send the waypoint(s) to the operator control unit 34 over communication link 42 and in turn the mission planner 36 sends the waypoint(s) to the robot over communication link 44. Any suitable wired or wireless communication technology may be utilized.

The software 16 computes the waypoint location, applies filtering algorithms to improve accuracy, packages the waypoint information into a language understandable by the mobile robot or other mission planning computing element, and communicates the information to the intended recipient. The process typically begins with the fusion of data from the sensing devices to estimate the target's location and additional post processing algorithms filter the data based on other operator inputs that dictate mission parameters for each waypoint. The data is packaged into a serial byte stream to prepare the data for digital transmission over wired or wireless communication means. Encapsulated within the transport protocol is the actual waypoint and mission data. This data may be encoded using any appropriate communications/control standard (e.g., the JAUS/SAE AS-4 standard).

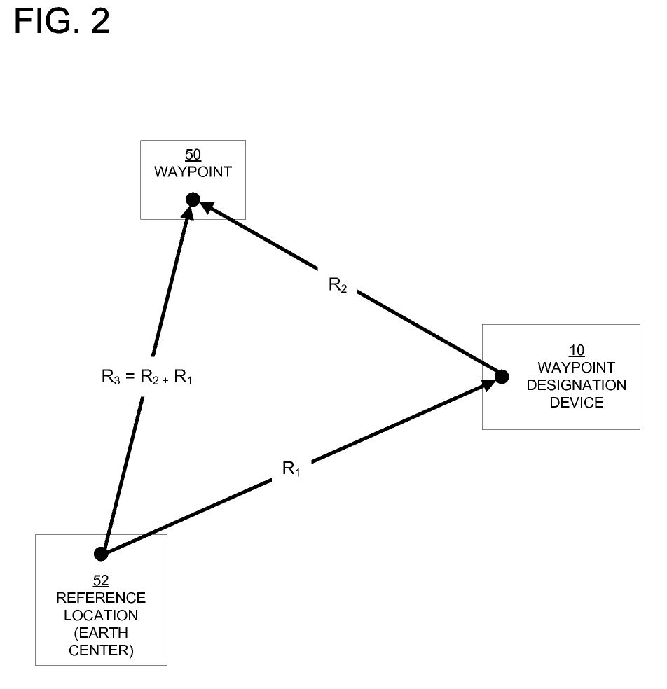

Embodiments of the invention may be capable of working in areas in which GPS service is available and in GPS-denied areas. FIG. 2 is a schematic block diagram illustrating a method for waypoint designation in a GPS-available area, in accordance with one embodiment of the invention. In a GPS-available area, the operator holds the device 10 up to his/her eyes, visually locates a target on earth (i.e., a desired waypoint 50) through a viewfinder, and depresses a button on the device that indicates that the operator would like to choose a navigation waypoint for the vehicle. The laser rangefinder determines the distance to the target and the electronic compass determines relative orientation of the device to the earth's coordinate frame 52. The distance and orientation defines vector R₂. The device's known earth reference (defined by vector R₁) is determined by the GPS receiver. The distance and orientation data is automatically combined with the device's known earth reference (from the GPS receiver) to determine a global waypoint that the vehicle should achieve. The waypoint location is defined by vector R₃ (where R₃=R₂+R₁). This waypoint data is packaged and transmitted to the UGV using the JAUS standard as the root protocol. The JAUS interoperable subsystem will interpret the incoming JAUS message. In this scenario, the message is a mission spooling message which contains a Set Global Waypoint message intended for the mobile robot's subsystem identification number. The JAUS system node manager then forwards this message to the mobile robot. Upon receipt, the waypoint is added to the queue of waypoints that the robot has been instructed to achieve. If the operator control unit has previously placed the mobile robot in a ready slate, the robot will begin navigation to the waypoints generated by the mobile robot laser position designating device. At anytime the operator may delete, add, or modify target waypoints either at the operator control unit or directly through the invented technology incorporated within the mobile robot laser position designation system.

FIG. 2 is a schematic block diagram illustrating a method for waypoint designation in a GPS-denied area, in accordance with one embodiment of the invention. In a GPS-denied area, the device must determine waypoints based off a coordinate frame other than the earth. In this scenario, the operator may use the vehicle's location as the reference. The invention determines the distance and orientation to the vehicle prior to selecting waypoints. As such, the operator raises the device 10 to his/her eye and visually locates the robot through the viewfinder. The operator depresses a calibration button on the device. The laser rangefinder determines the distance to the robot and the electronic compass determines relative orientation of the device to the robot (specifically to a reference point 54 on the robot, i.e., the center of the robot), thereby establishing vector R₁. Not moving significantly from his/her current location, the operator chooses a target waypoint 50 as described in the first scenario, thereby establishing vector R₂. The device is able to use the calibration information (i.e., the reference location 54) to facilitate the calculation of a local waypoint that the vehicle should achieve. The waypoint location is defined by vector R₃ (where R₃=R₂−R₁). Referenced to the instantaneous vehicle position, this waypoint is spooled to the operator control unit in the same way as described in the first scenario, except that a different JAUS message may be utilized that commands a local waypoint rather than a global waypoint.

In one embodiment of the invention, the device may be capable of automatically determining if GPS is available and selecting the mode of operation based on whether GPS is available. If global position is available (adequate GPS position fix), the device will operate as described in the first scenario above. If global position is unavailable (GPS-denied environment), the device will operate as described in the second scenario above. In this second operating mode, the device will typically alert the operator to first calibrate the device using the vehicle location or another known frame within visual range prior to selecting waypoints.

The JAUS messages, which are traditionally sent over an IP (Internet protocol) based network, may be compressed to a proprietary message format that requires less bandwidth. The messages may be sent using a serial radio modem. The messages may be received at the other end of the link and modified back to the original uncompressed JAUS messages.

In one specific embodiment of the invention, the user input element 28 comprises three different buttons (which may be labeled “vehicle,” “target,” and “run/pause”) that the operator uses to command the robot to travel down range. First, the operator sights the vehicle through the viewfinder. The operator then presses the “vehicle” button, thereby causing the device to clear the previous mission, place the robot in a standby mode, and, if GPS is unavailable, obtain a reference vector to the robot. This reference vector is computed by ranging distance, heading and inclination to the target using the onboard distance and orientation sensors. Without a GPS signal, the device will use the reference vector to compute target locations in the next step of the mission loading process. The second step is to build up a list of targets for the mission. This is accomplished by sighting the targets through the viewfinder and depressing the “target” button. Measurement time may be about one second, and the device may indicate that a valid target has been designated (e.g., by an audible beep). In one embodiment of the invention, the operator may load up to 65,536 targets. Lastly, the operator commands the robot to start the mission by clicking the “run/pause” button. This causes the device to transmit the appropriate JAUS message to the mission planner or waypoint driver.

The robot, which at this point is entirely controlled by the waypoint driver, will begin moving toward the first targeted location. The travel speed is typically an adjustable setting on the waypoint driver and is only limited by the maximum attainable speed of the robotic platform. At anytime during the mission, the operator may “pause” the mission by clicking the “run/pause” button. At this point the operator may take control of the robot if necessary. Alternatively, since the mission has not been canceled, the operator can place the robot back into run mode by clicking the “run/pause” button and the robot will resume the mission. This is very useful if the robot encounters an obstacle or has become stuck. Additionally, at any time the operator may depress and hold down the “target” button and point in the direction the operator wants the robot to travel. This causes the device to determine a heading and command the robot to simply travel along that heading as long as the “target” button his held down. This feature is very useful for driving the robot out of a vehicle or simply having the robot follow the operator.

Since ranging information may be displayed in the viewfinder, the device can be used for any number of other tasks requiring target localization. Additionally, the waypoint information can be conveyed to systems and devices other than UGVs. For example, the device can be used to target ordnance. The desired target can be designated with the device, and the location information can be transmitted to an ordnance control system.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A device for waypoint designation comprising:
a distance sensor configured for determining a distance between the device and a desired waypoint;
an orientation sensor configured for determining a heading and a pitch of the device when the device is pointed at the desired waypoint;
a position sensor configured for determining a position of the device; and
a controller configured for determining a position of the desired waypoint using the heading, pitch, and position of the device and the distance between the device and the desired waypoint.

2. The device of claim 1, further comprising:
a user input element for receiving an input from a user when the device is pointed at the desired waypoint;
wherein the distance sensor determines the distance between the device and the desired waypoint when the user input is received; wherein the orientation sensor determines the heading and pitch of the device when the user input is received; and wherein the position sensor determines the position of the device when the user input is received.

3. The device of claim 1, wherein the distance sensor comprises a laser rangefinder.

4. The device of claim 1, wherein the orientation sensor comprises an electronic compass.

5. The device of claim 1, wherein the position sensor comprises a global positioning system receiver.

6. The device of claim 1, further comprising:
a sighting element aligned with the distance sensor such that the viewing the desired waypoint in the sighting element causes the distance sensor to be pointed at the desired waypoint.

7. The device of claim 1, further comprising:
a communication element configured for communicating the position of the desired waypoint to an ordnance fire control system.

8. The device of claim 1, further comprising:
a communication element configured for communicating with a mobile ground robot;
wherein the controller is further configured for sending, via the communication element, the determined position of the desired waypoint to the mobile ground robot, thereby causing the mobile ground robot to (i) move to the desired waypoint and/or (ii) perform a desired action at the desired waypoint.

9. A method for waypoint designation using a waypoint designation device, the waypoint designation device comprising a distance sensor, an orientation sensor, a position sensor, and a controller, the method comprising:
determining, by the distance sensor, a distance between the waypoint designation device and a desired waypoint;
determining, by the orientation sensor, a heading and a pitch of the waypoint designation device when the waypoint designation device is pointed at the desired waypoint;
determining, by the position sensor, a position of the waypoint designation device; and
determining, by the controller, a position of the desired waypoint using the heading, pitch, and position of the waypoint designation device and the distance between the waypoint designation device and the desired waypoint.

10. The method of claim 9, further comprising:
receiving an input from a user via a user input element when the device is pointed at the desired waypoint;
wherein the distance sensor determines the distance between the device and the desired waypoint when the user input is received; wherein the orientation sensor determines the heading and pitch of the device when the user input is received; and wherein the position sensor determines the position of the device when the user input is received.

11. The method of claim 9, wherein the distance sensor comprises a laser rangefinder.

12. The method of claim 9, wherein the orientation sensor comprises an electronic compass.

13. The method of claim 9, wherein the position sensor comprises a global positioning system receiver.

14. The method of claim 9, wherein the waypoint designation device further comprises a sighting element aligned with the distance sensor such that the viewing the desired waypoint in the sighting element causes the distance sensor to be pointed at the desired waypoint.

15. The method of claim 9, further comprising:
communicating, via a communication element, the position of the desired waypoint to an ordnance fire control system.

16. The method of claim 9, further comprising:
sending, via a communication element, the determined position of the desired waypoint to a mobile ground robot, thereby causing the mobile ground robot to (i) move to the desired waypoint and/or (ii) perform a desired action at the desired waypoint.

17. A method for waypoint designation using a waypoint designation device, the waypoint designation device comprising a distance sensor, an orientation sensor, a position sensor, and a controller, the method comprising:
determining, by the distance sensor, a distance between the waypoint designation device and a known location;
determining, by the orientation sensor, a heading and a pitch of the waypoint designation device when the waypoint designation device is pointed at the known location;
determining, by the distance sensor, a distance between the waypoint designation device and a desired waypoint;
determining, by the orientation sensor, a heading and a pitch of the waypoint designation device when the waypoint designation device is pointed at the desired waypoint; and
determining, by the controller, a position of the desired waypoint using the heading and pitch of the waypoint designation device when the waypoint designation device is pointed at the known location, the distance between the waypoint designation device and the known location, the heading and pitch of the waypoint designation device when the waypoint designation device is pointed at the desired waypoint, and the distance between the waypoint designation device and the desired waypoint.

18. The method of claim 17, further comprising:
receiving a first input from a user via a user input element when the device is pointed at the known location;
receiving a second input from a user via the user input element when the device is pointed at the desired waypoint;
wherein the distance sensor determines the distance between the device and the known location when the first user input is received; wherein the orientation sensor determines the heading and pitch of the device when the first user input is received; wherein the distance sensor determines the distance between the device and the desired waypoint when the second user input is received; and wherein the orientation sensor determines the heading and pitch of the device when the second user input is received.

19. The method of claim 17, wherein the distance sensor comprises a laser rangefinder.

20. The method of claim 17, wherein the orientation sensor comprises an electronic compass.

21. The method of claim 17, wherein the waypoint designation device further comprises a sighting element aligned with the distance sensor such that the viewing the desired waypoint in the sighting element causes the distance sensor to be pointed at the desired waypoint.

22. The method of claim 17, wherein the known location is a location of a mobile ground robot.

23. The method of claim 17, further comprising:
sending, via a communication element, the determined position of the desired waypoint to a mobile ground robot, thereby causing the mobile ground robot to (i) move to the desired waypoint and/or (ii) perform a desired action at the desired waypoint.

24. A method for waypoint designation using a waypoint designation device, the waypoint designation device comprising a distance sensor, an orientation sensor, a position sensor, and a controller, the method comprising:
determining, by the distance sensor, a distance between the waypoint designation device and each of a plurality of desired waypoints;
determining, by the orientation sensor, a heading and a pitch of the waypoint designation device when the waypoint designation device is pointed at each of the plurality of desired waypoints;
determining, by the position sensor, a position of the waypoint designation device; and
determining, by the controller, a position of each of the plurality of desired waypoints using the heading, pitch, and position of the waypoint designation device and the distance between the waypoint designation device and each of the plurality of desired waypoints.

25. The method of claim 24, further comprising:
receiving an input from a user via a user input element each time the device is pointed at one of the plurality of desired waypoints;
wherein the distance sensor determines the distance between the device and each of the desired waypoints when the corresponding user input is received; wherein the orientation sensor determines the heading and pitch of the device when each user input is received; and wherein the position sensor determines the position of the device when each user input is received.

26. The method of claim 24, wherein the distance sensor comprises a laser rangefinder, wherein the orientation sensor comprises an electronic compass, and wherein the position sensor comprises a global positioning system receiver.

27. The method of claim 24, wherein the waypoint designation device further comprises a sighting element aligned with the distance sensor such that the viewing any of the desired waypoints in the sighting element causes the distance sensor to be pointed at that desired waypoint.

28. The method of claim 24, wherein the plurality of desired waypoints define a path for a mobile ground robot to travel, and wherein the method further comprises:
sending, via a communication element, the determined positions of each of the plurality of desired waypoints to the mobile ground robot, thereby causing the mobile ground robot to travel along the defined path.

29. The method of claim 24, wherein the plurality of desired waypoints define a perimeter for a mobile ground robot to stay within, and wherein the method further comprises:
sending, via a communication element, the determined positions of each of the plurality of desired waypoints to the mobile ground robot, thereby causing the mobile ground robot to stay within the defined perimeter.
